(19) United States
(12) Patent Application Publication
(10) Pub. No.: US 2025/0229638 A1
(43) Pub. Date: Jul. 17, 2025

(54) ELECTRIC VEHICLE BRAKING ASSIST SYSTEM

(71) Applicant: Textron Inc., Providence, RI (US)

(72) Inventors: Gregory August Theodosakis, Martinez, GA (US); Russell William King, Evans, GA (US); Christian Antwi, Augusta, GA (US)

(73) Assignee: Textron Inc., Providence, RI (US)

(21) Appl. No.: 18/411,766

(22) Filed: Jan. 12, 2024

(51) Int. Cl. B60L 7/26; B60L 15/20

(52) U.S. Cl. CPC B60L 7/26; B60L 15/2018; B60L 2240/421; B60L 2240/427; B60L 2240/549; B60L 2240/642; B60L 2250/26

(57) ABSTRACT

A braking assist method for a vehicle is described and includes receiving a brake switch signal indicative of a state of a mechanical brake actuation system; receiving a motor speed signal indicative of a speed of a traction motor, the traction motor for applying rotational torque to a wheel of the vehicle; determining from changes in a value of the received motor speed signal over time a rate of change of the traction motor speed; and, based on a determination that the mechanical brake actuation system is in an on state and that the rate of change of the traction motor speed is decreasing, commanding the traction motor to apply a supplemental braking torque to the wheel.

### TECHNICAL FIELD

This disclosure relates in general to the field of lightweight utility vehicles, such as golf carts and, more particularly, though not exclusively, to a system for implementing electric motor braking based on mechanical braking force inference in connection with such vehicles.

### BACKGROUND

Lightweight electric utility vehicles (LEUVs), such as golf carts, are increasingly becoming a popular mode of transportation for both golfers as well as people who live in gated communities. LEUVs are quiet and eco-friendly, making them a desirable alternative to gas-powered vehicles. LEUV mechanical (including hydraulic) brakes differ from automobile brakes in that they are generally less efficient than automobile brakes and require more force to stop the vehicle. Moreover, the heavier the LEUV, the more braking torque required to stop the vehicle. Heavy electric vehicles can require more braking performance than certain mechanical brake systems (including hydraulic brake systems) can provide. Many electric vehicle powertrain systems are capable of regenerative braking, but regenerative braking typically operates based only on the release of the accelerator pedal or requires additional (and typically expensive) components to operate based on brake pedal input.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates an LEUV in connection with which embodiments described herein for an electric vehicle braking assist system may be implemented;

FIGS. 2A and 2B illustrate simplified block diagrams of an example system in which electric vehicle braking assist features according to features of embodiments described herein may be implemented;

FIG. 3 is a flowchart illustrating example operations that may be performed by an electric vehicle braking assist system according to features of embodiments described herein; and

FIG. 4 is a block diagram of an example computer system that may be used to implement all or some portion of an electric vehicle braking assist system according to features of embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, “raised”, “lowered”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of a vehicle relative to another component or component aspect(s). The term “aft” may refer to a spatial direction that is closer to a rear of a vehicle relative to another component or component aspect(s). The term “inboard” may refer to a location of a component that is within the fuselage of a vehicle and/or a spatial direction that is closer to or along a centerline of the vehicle (wherein the centerline runs between the front and the rear of the vehicle) or other point of reference relative to another component or component aspect. The term “outboard” may refer to a location of a component that is outside the fuselage of a vehicle and/or a spatial direction that is farther from the centerline of the vehicle or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

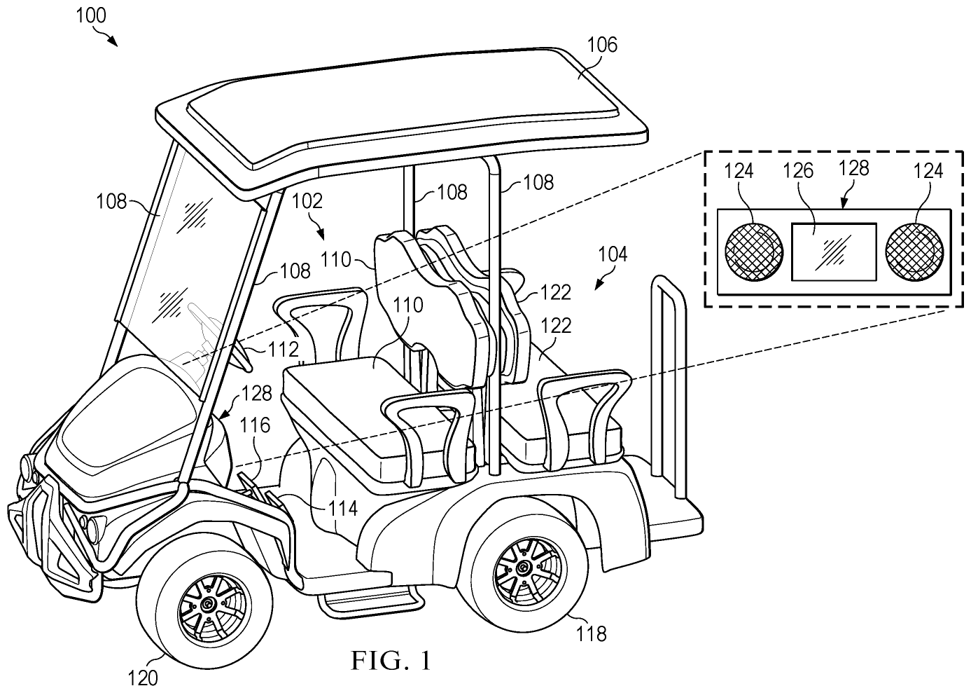

FIG. 1 illustrates a vehicle 100 in connection with which embodiments described herein for an electric vehicle braking assist system may be implemented. In particular embodiments, vehicle 100 may be an LEUV. As shown in FIG. 1, vehicle 100 is generally an open cabin vehicle, such as a golf cart, a utility vehicle, a maintenance vehicle, a cargo vehicle, a shuttle vehicle, a personal transportation vehicle, etc., that includes a main passenger seating area 102, an auxiliary passenger seating area 104 disposed behind the main passenger seating area 102, and a canopy 106 primarily disposed over the main passenger seating area 102. Canopy 106 may be mounted to vehicle 100 and supported over (or above) main passenger seating area 102 via support struts 108. In particular embodiments support struts 108 may provide a rollover protection system (ROPS) for the vehicle 100.

The main passenger seating area 102 generally includes a primary seating structure 110, a steering wheel 112 for use by an operator (or driver) of the vehicle 100 to control the directional movement of the vehicle, a brake pedal 114 for use by the vehicle operator to control slowing and stopping of the vehicle, and an accelerator pedal 116 for use by the vehicle operator to control the torque delivered by one or more vehicle prime movers (not shown) to one or more rear wheels 118 and one or more front wheels 120. Auxiliary passenger seating area 104 generally includes an auxiliary seating structure 122 that can be attached to the rear portion of vehicle 100 behind primary seating structure 110 to provide additional seating capacity for the vehicle. More particularly, auxiliary seating structure 122 provides seating capacity in addition to that provided by the primary seating structure 110. Primary seating structure 110 is generally structured and operable to accommodate a vehicle operator and at least one passenger in a forward-facing (i.e., toward the front of vehicle 100) position, while auxiliary seating structure 122 is generally structured and operable to accommodate at least two passengers in a rearward-facing (i.e., toward the rear of vehicle 100) position. In particular embodiments, vehicle 100 includes one or more speakers 124 and a display 126, all of which may be provided on a dashboard 128 of vehicle 100. One or more controls associated with speakers 124 and display 126 may also be provided on or near dashboard 128.

In accordance with features of embodiments described herein, a rate of change of the speed of an electric vehicle, such as vehicle 100, in conjunction with other parameters, signals, and sensor data, can be used to indicate when a mechanical braking system is being actuated by a vehicle operator. Additionally, the presence of a braking force applied by the operator to the brake pedal, such as brake pedal 114, can be inferred from a brake switch signal that is activated when the brake pedal of the mechanical braking system is depressed. In some embodiments, an analog pressure sensor may be used to indicate an amount of braking force applied by the operator to the brake pedal.

When the magnitude of the motor's angular acceleration is high enough (e.g., vehicle exceeds an acceleration threshold of magnitude 0.3G) that application of more braking torque would be beneficial, regenerative braking can be applied by the electric motor of the vehicle to improve the braking performance of the vehicle. In accordance with features of embodiments described herein, such improved braking performance can be achieved without modification of the mechanical brake system (i.e., by adding potentially complicated and expensive analog brake system sensors to the system) and without permanently altering vehicle parameters (e.g., without reducing the top speed of the vehicle). As used herein, mechanical braking systems include mechanical cable-based, hydraulic line-based, and other non-electrical braking systems.

In particular embodiments, one or more of the rate of change of motor speed, the brake light switch of the vehicle, direction selection, and an estimate of the grade on which the vehicle is operating (e.g., as determined by an inertial measurement unit (IMU)) may be monitored during operation of a vehicle, such as vehicle 100. It will be recognized that motor speed may be expressed in revolutions per minute (RPM), rate of change of motor speed may be expressed in RPM/second (RPM/s), and deceleration may be expressed in Gs and may be based on rate of change of motor speed. It will further be recognized that an IMU is an electronic sensing device that measures and reports the specific force, angular rate, acceleration, and/or orientation of a body on which it is installed. In particular embodiments, an IMU detects linear acceleration of the body using one or more accelerometers and rotational rate of the body using one or more gyroscopes. An IMU may also include one or more magnetometers for use as a heading reference. In a typical configuration, an IMU may include one accelerometer, one gyroscope, and one magnetometer per axis for each of three principal axes (e.g., pitch, roll, yaw (or x, y, z)). As used herein, IMU refers to any combination of accelerometers, gyroscopes and/or magnetometers that together perform the aforementioned purposes of an IMU.

The rate of change of wheel RPM (as indicated by a traction motor RPM signal) may function as a principal control signal in the electric vehicle braking assist system described herein. When the rate of change is significantly negative (i.e., when the vehicle is decelerating), system logic will increase the deceleration rate of the motor sufficiently to meet braking performance requirements. In particular embodiments, some form of interpolation between a threshold deceleration and maximum/saturation deceleration may be applied to smooth the effect. Activation of the braking assist system may be contingent on the accelerator pedal being fully released. A brake light switch may be used for plausibility, such that operation of the electric vehicle braking assist feature may be made conditional upon switch closure to prevent the occurrence of such assistance when the brake pedal is not being pressed. IMU feedback may be used as an additional plausibility refinement and may be specifically directed toward deactivating the electric vehicle braking assist feature when the vehicle is traversing up an incline. In particular, traveling up an incline can have a negative effect on vehicle wheel deceleration similar to pressing the brake pedal that could cause the braking assist logic to trigger undesirably when the vehicle is traveling up a hill. It will be recognized that disabling (or not activating) the braking assist feature while the vehicle is traveling up an incline is acceptable in view of the fact that the force of gravity effectively increases the performance of the braking system by acting in the same direction as the braking force. Vehicle speed may also be considered as another plausibility check in triggering, or activating, the brake assist system described herein. For example, in particular embodiments, the braking assist system may only be activated, or involved, at vehicle speeds in excess of a predetermined vehicle speed threshold (e.g., 18 miles per hour (MPH).

Additionally and/or alternatively, in situations in which an extreme amount of braking torque is required, an electromagnetic parking brake could be engaged to provide even more braking torque. For example, if a determination is made that any current limits (e.g., motor current limits or battery current limits) or thresholds have been exceeded when supplementary braking torque is applied with the motor, the electromagnetic parking brake could be engaged to provide additional braking torque.

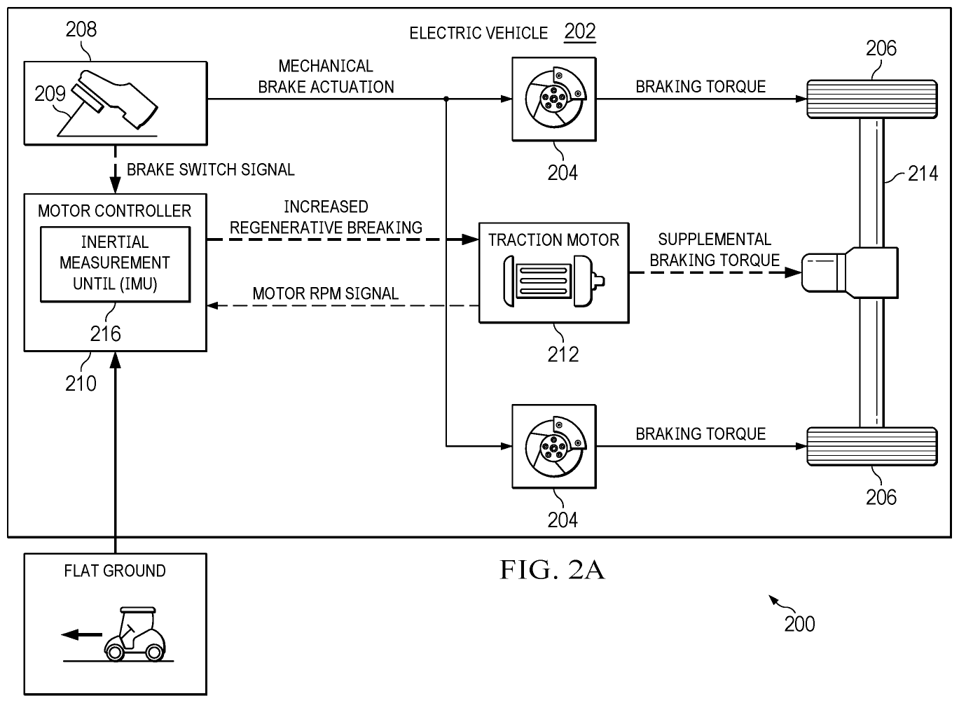

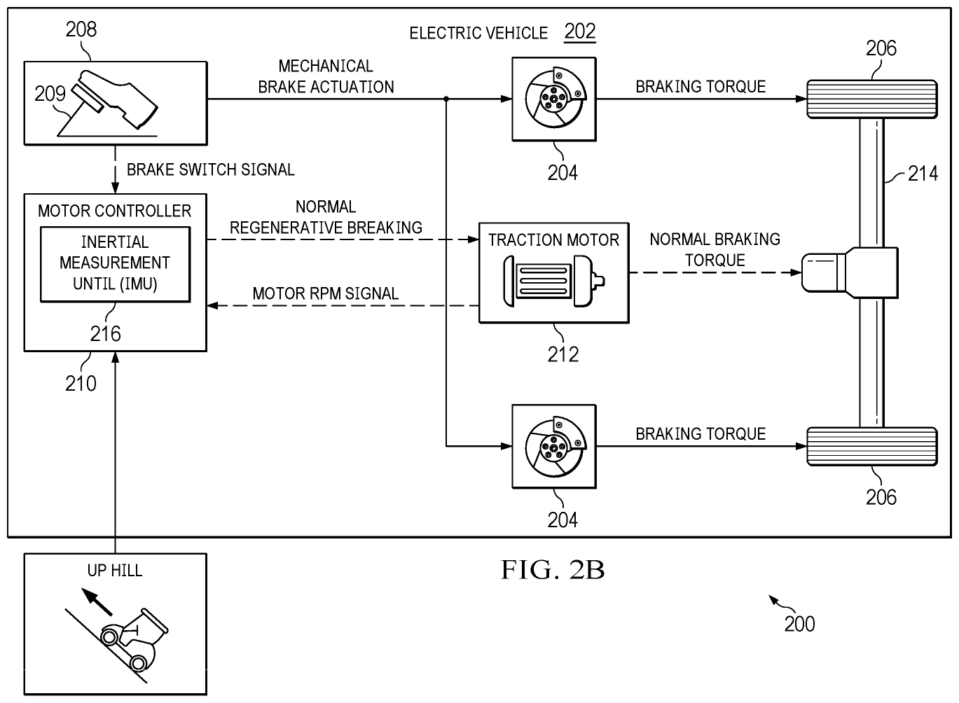

FIGS. 2A and 2B illustrate a simplified block diagram of an example system 200 for implementing an electric vehicle braking assist feature according to features of embodiments described herein. As shown in FIG. 2, system 200 is implemented in a vehicle 202, which may be identical in all relevant respects to vehicle 100 (FIG. 1). As shown in FIGS. 2A and 2B, vehicle 202 includes mechanical brake assemblies 204 for applying braking forces to wheels 206 in response to a mechanical brake actuation system 208 comprising a brake pedal 209, which may be analogous to brake pedal 114 (FIG. 1). Mechanical brake assemblies 204 may be implemented as cable and drum assemblies or hydraulic assemblies, for example. In particular embodiments, mechanical brake actuation system 208 and mechanical brake assemblies 204 may include an electromagnetic parking brake and a system for actuating same.

System 200 includes a motor controller 210 provided for controlling the speed (in RPM) of a traction motor 212 for applying rotational torque to wheels 206 via an axle 214. Motor controller 210 monitors an RPM of traction motor 212. An IMU 216 provides signals to motor controller 210 indicative of the grade of the surface being traversed by vehicle 202 at any given time. In accordance with features of embodiments described herein, traction motor 212 may be operable to provide supplemental braking torque to wheels 206 in response to an increased regenerative braking command from motor controller 210.

In operation, when brake pedal 209 is pressed by an operator of vehicle 202, motor controller 210 receives a brake switch signal from mechanical brake actuation system 208 to indicate that the brake pedal has been pressed. In particular embodiments, motor controller 210 may infer from switch signal whether the brake pedal 209 is pressed. In the example illustrate in FIG. 2A, when vehicle 202 is traversing a flat or negative grade (downhill) surface, as indicated by signals generated by IMU 216, the speed, or RPM, of traction motor 212 is decreasing (indicative of vehicle deceleration), and the brake switch signal indicates that brake pedal 209 is being pressed and mechanical brake actuation system 208 is actuated, motor controller 210 generates an increased regenerative braking command to traction motor 212 in response to which traction motor applies supplemental braking torque (i.e., braking assist) to wheels 206 via axle 214.

Referring now particularly to FIG. 2B, in the example illustrated therein, when vehicle 202 is traversing a positive grade (uphill) surface, as indicated by signals generated by IMU 216, regardless of whether the RPM of traction motor 212 is decreasing or the brake switch signal indicates that brake pedal 209 has been pressed and mechanical brake actuation system 208 has been actuated, motor controller 210 refrains from generating a increased regenerative braking command to traction motor 212 and instead generates a normal regenerative braking command to traction motor 212 in response to which traction motor applies normal braking torque to wheels 206 via axle 214.

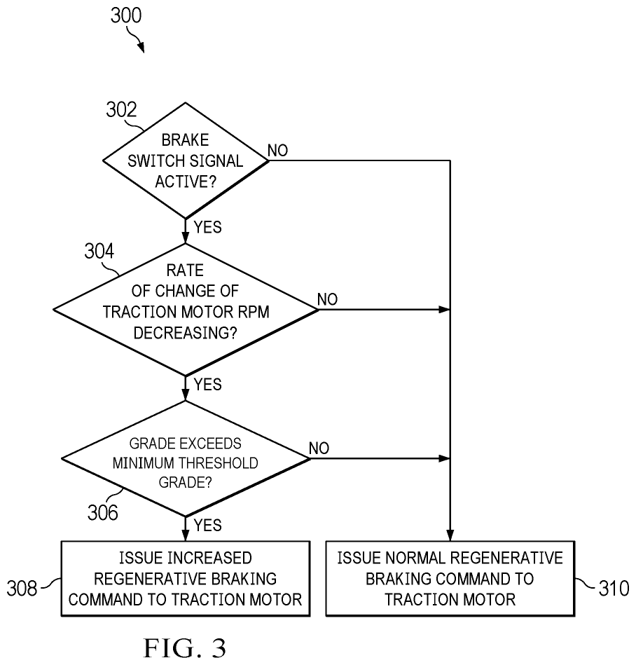

FIG. 3 is a flowchart 300 illustrating example operations performed by a system for implementing a braking assist feature in an electric vehicle, such as vehicle 200, according to features of embodiments described herein. In certain embodiments, one or more of the operations illustrated in FIG. 3 may be executed by one or more of the elements shown in FIGS. 2A and 2B, for example.

In operation 302, a determination is made whether a brake switch signal output by a mechanical brake actuation system, such as mechanical brake actuation system 208, is active, indicating that the brake pedal (e.g., brake pedal 209) of the vehicle is being pressed. In particular embodiments, in addition to simply indicating whether (ON) or not (OFF) the brake pedal is being pressed, brake switch signal may indicate that the brake pedal is being pressed and/or may provide data from which such information may be inferred. If the brake switch signal is active, execution proceeds to operation 304.

In operation 304, a determination is made whether the rate of change of the traction motor RPM, as indicated by a motor RPM signal, is decreasing, indicating that the vehicle is decelerating. As noted above, this may function as a principal control signal in the electric vehicle braking assist system described herein. In particular embodiments, when the rate of change of RPM is significantly negative (e.g., as compared to an established vehicle acceleration threshold value of approximately −0.3G), a positive determination will be made in operation 304 and execution proceeds to operation 306.

In operation 306, a determination is made whether the grade of the surface the vehicle is currently traversing exceeds an established minimum threshold grade. In particular, in operation 306, a determination is made whether the vehicle is traveling uphill, in which case braking assist is not necessary for reasons described in detail above. If a negative determination is made in step 306, indicating that the vehicle is traversing a relatively flat and/or downhill surface, execution proceeds to operation 308.

In operation 308, the braking assist feature is activated and traction motor is commanded to increase the supplemental braking torque applied to the wheels. In particular embodiments, motor controller will command traction motor to increase its deceleration rate sufficiently to meet braking performance requirements, e.g., based on the amount of brake pedal pressure applied, the grade of the surface being traversed by the vehicle and/or the rate of RPM deceleration detected. In particular embodiments, some form of interpolation between a threshold deceleration (e.g., −0.3G) and maximum/saturation deceleration (e.g., −0.49G) may be applied to smooth the effect of deceleration on the vehicle.

It will be recognized that an amount of supplemental braking torque commanded to be applied may be determined using a model, a look up table, or other programmable algorithm designed and implemented for such purpose. It will be further recognized that other factors, variables and/or information that may impact an amount of supplemental braking torque that may be useful, such as characteristics of the vehicle itself (e.g., vehicle weight, vehicle center of gravity, etc.), characteristics of the environment in which the vehicle is operating (e.g., the type of surface on which the vehicle is being operated, the pedestrian density of the area in which the vehicle is being operated, etc.), or environmental characteristics (e.g., weather), may be considered in determining the amount of supplemental braking torque to apply in a given scenario and that the braking assist system may be customizable and/or programmable to account for changes in such factors.

If a negative determination is made in either of operations 302 or 304 or a positive determination is made in operation 306, execution proceeds to operation 310, in which the braking assist feature remains inactive and traction motor is commanded to apply normal braking torque to wheels.

Although the operations of the example method shown in and described with reference to FIG. 3 are illustrated as occurring once each and in a particular order, it will be recognized that the operations may be performed in any suitable order and repeated as desired. Additionally, one or more operations may be performed in parallel or simultaneously. Furthermore, the operations illustrated in FIG. 3 may be combined or may include more or fewer details than described.

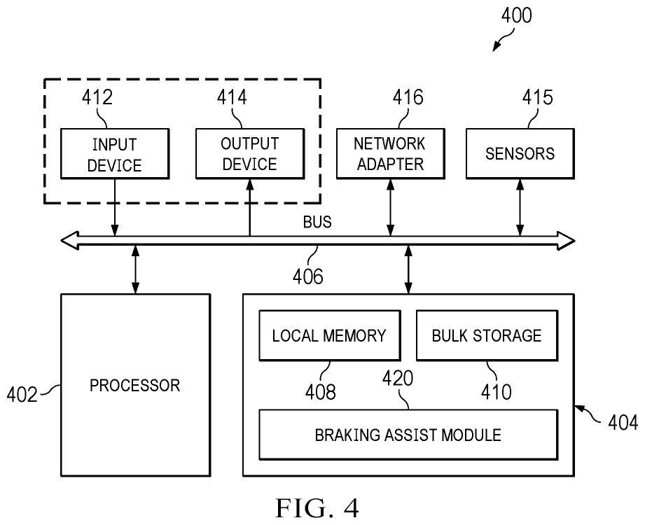

FIG. 4 is a block diagram illustrating an example system 400 that may be configured to implement at least portions of techniques in accordance with embodiments described herein, and more particularly as shown in the FIGURES described hereinabove. For example, one or more elements of system 400 may be employed to implement motor controller 210 (FIGS. 2A and 2B). As shown in FIG. 4, the system 400 may include at least one processor 402, e.g., a hardware processor 402, coupled to memory elements 404 through a system bus 406. As such, the system may store program code and/or data within memory elements 404. Further, the processor 402 may execute the program code accessed from the memory elements 404 via a system bus 406. In one aspect, the system may be implemented as a computer that is suitable for storing and/or executing program code. It should be appreciated, however, that the system 400 may be implemented in the form of any system including a processor and a memory that is capable of performing the functions described in this disclosure.

In some embodiments, the processor 402 can execute software or an algorithm to perform the activities as discussed in this specification; in particular, activities related to embodiments described herein. The processor 402 may include any combination of hardware, software, or firmware providing programmable logic, including by way of non-limiting example a microprocessor, a DSP, a field-programmable gate array (FPGA), a programmable logic array (PLA), an integrated circuit (IC), an application specific IC (ASIC), or a virtual machine processor. The processor 402 may be communicatively coupled to the memory element 404, for example in a direct-memory access (DMA) configuration, so that the processor 402 may read from or write to the memory elements 404.

In general, the memory elements 404 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the system 400 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in the present figures may also include suitable interfaces for receiving, transmitting, and/or otherwise communicating data or information in a network environment so that they can communicate with, for example, a system having hardware similar or identical to another one of these elements.

In certain example implementations, mechanisms for implementing embodiments as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as e.g., the memory elements 404 shown in FIG. 4 can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as e.g., the processor 402 shown in FIG. 4, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 404 may include one or more physical memory devices such as, for example, local memory 408 and one or more bulk storage devices 140. The local memory may refer to RAM or other non-persistent memory device(s) generally used during actual execution of the program code. A bulk storage device may be implemented as a hard drive or other persistent data storage device. The processing system 400 may also include one or more cache memories (not shown) that provide temporary storage of at least some program code in order to reduce the number of times program code must be retrieved from the bulk storage device 140 during execution.

As shown in FIG. 4, the memory elements 404 may store a braking assist module 420. In various embodiments, the module 420 may be stored in the local memory 408, the one or more bulk storage devices 140, or apart from the local memory and the bulk storage devices. It should be appreciated that the system 400 may further execute an operating system (not shown in FIG. 4) that can facilitate execution of the module 420. The module 420, being implemented in the form of executable program code and/or data, can be read from, written to, and/or executed by the system 400, e.g., by the processor 402. Responsive to reading from, writing to, and/or executing the module 420, the system 400 may be configured to perform one or more operations or method steps described herein (e.g., in FIG. 3).

Input/output (I/O) devices depicted as an input device 412 and an output device 414, optionally, may be coupled to the system. Examples of input devices may include, but are not limited to, a keyboard, a pointing device such as a mouse, or the like. Examples of output devices may include, but are not limited to, a monitor or a display, speakers, or the like. In some implementations, the system may include a device driver (not shown) for the output device 414. Input and/or output devices 412, 414 may be coupled to the system 400 either directly or through intervening I/O controllers. Additionally, sensors 415 may be coupled to the system 400 either directly or through intervening controllers and/or drivers.

In an embodiment, the input and the output devices may be implemented as a combined input/output device (illustrated in FIG. 4 with a dashed line surrounding the input device 412 and the output device 414). An example of such a combined device is a touch sensitive display, also sometimes referred to as a “touch screen display” or simply “touch screen.” In such an embodiment, input to the device may be provided by a movement of a physical object, such as, e.g., a stylus or a finger of a user, on or near the touch screen display.

A network adapter 416 may also, optionally, be coupled to the system 400 to enable it to become coupled to other systems, computer systems, remote network devices, and/or remote storage devices through intervening private or public networks. The network adapter may comprise a data receiver for receiving data that is transmitted by said systems, devices and/or networks to the system 400, and a data transmitter for transmitting data from the system 400 to said systems, devices and/or networks. Modems, cable modems, and Ethernet cards are examples of different types of network adapter that may be used with the system 400.

Example 1 provides a braking assist method for a vehicle, the method including receiving a brake switch signal indicative of a state of a mechanical brake actuation system; receiving a motor speed signal indicative of a speed of a traction motor, the traction motor for applying rotational torque to a wheel of the vehicle; determining from changes in a value of the received motor speed signal over time a rate of change of the traction motor speed; and based on a determination that the mechanical brake actuation system is in an on state and that the rate of change of the traction motor speed is decreasing, commanding the traction motor to apply a supplemental braking torque to the wheel.

Example 2 provides the braking assist method of example 1, in which the mechanical brake actuation system includes a brake pedal, the method further including determining from the brake switch signal whether the brake pedal has been pressed by an operator of the vehicle.

Example 3 provides the braking assist method of example 2, further including determining an amount of pressure applied to the brake pedal and preventing the commanding while the pressure is less than a predetermined threshold amount.

Example 4 provides the braking assist method of any one of examples 1-3, further including determining an amount of the supplemental braking torque to be applied based at least in part on the rate of change of the traction motor speed.

Example 5 provides the braking assist method of any one of examples 1-4, further including determining whether a current threshold of at least one of the traction motor or a battery of the vehicle has been exceeded; and based on a determination that the current threshold has been exceeded, engaging a parking brake of the vehicle to provide an additional braking force.

Example 6 provides the braking assist method of any one of examples 1-5, further including determining a grade of a surface being traversed by the vehicle; and preventing the commanding while the grade is greater than a predetermined threshold grade.

Example 7 provides the braking assist method of example 6, in which the determining the grade of the surface is performed using signals received from an inertial measurement unit (IMU).

Example 8 provides the braking assist method of any one of examples 1-7, further including determining an amount of the supplemental braking torque to be applied, in which the determined amount of supplemental braking torque, when applied, causes the vehicle to decelerate at a rate greater than a minimum threshold deceleration rate and less than a maximum deceleration rate.

Example 9 provides an electric vehicle including a braking assist system, the electric vehicle including a mechanical brake actuation system for actuating a mechanical braking assembly in connection with a wheel of the vehicle; a traction motor for applying rotational torque to the wheel; and a motor controller for controlling the traction motor, the motor controller configured to receive a brake switch signal indicative of a state of the mechanical brake actuation system and a motor speed signal indicative of a speed of the traction motor; in which the motor controller is further configured to: determine from changes in the received motor speed signal over time a rate of change of the traction motor speed; and based on a determination that the mechanical brake actuation system is in an on state and that the rate of change of the traction motor speed is decreasing, command the traction motor to apply a supplemental braking torque to the wheel.

Example 10 provides the vehicle of example 9, in which the mechanical brake actuation system includes a brake pedal, and in which the motor controller is further configured to determine from the brake switch signal an amount of pressure applied to the brake pedal by an operator of the vehicle.

Example 11 provides the vehicle of example 10, in which the motor controller is further configured to refrain from the commanding while the pressure is less than a predetermined threshold amount.

Example 12 provides the vehicle of example 10 or 11, in which the motor controller is further configured to determine an amount of the supplemental braking torque to be applied based at least in part on the rate of change of the traction motor speed and the amount of pressure applied to the brake pedal.

Example 13 provides the vehicle of any one of examples 9-12, in which the motor controller is further configured to: determine whether a current threshold of at least one of the traction motor or a battery of the vehicle has been exceeded; and based on a determination that the current threshold has been exceeded, engage a parking brake of the vehicle to provide an additional braking force.

Example 14 provides the vehicle of any one of examples 9-13, in which the motor controller is further configured to: determine a grade of a surface being traversed by the vehicle; and refrain from the commanding while the grade is greater than a predetermined threshold grade.

Example 15 provides the vehicle of any one of examples 9-14 further including an inertial measurement unit (IMU), in which the grade of the surface being traversed is performed using signals received from the IMU.

Example 16 provides the vehicle of any one of examples 9-15, in which the motor controller is further configured to determine an amount of the supplemental braking torque to be applied, in which the determined amount of supplemental braking torque, when applied, causes the vehicle to decelerate at a rate greater than a minimum threshold deceleration rate and less than a maximum deceleration rate.

Example 17 provides a braking assist system for an electric vehicle, the braking assist system including a motor controller configured to receive a brake switch signal indicative of a state of a mechanical brake actuation system of the vehicle and a motor speed signal indicative of a speed of a traction motor of the vehicle, in which the motor controller is further configured to: determine from changes in the received motor speed signal over time a rate of change of the traction motor speed; and based on a determination that the mechanical brake actuation system is in an on state and that the rate of change of the traction motor speed is decreasing, command the traction motor to apply a supplemental braking torque to the wheel.

Example 18 provides the braking assist system of example 17 in which the mechanical brake actuation system includes a brake pedal, and in which the motor controller is further configured to determine from the brake switch signal an amount of pressure applied to the brake pedal by an operator of the vehicle and to refrain from the issuing the supplemental braking torque command while the pressure is less than a predetermined threshold amount.

Example 19 provides the braking assist system of example 18, in which the motor controller is further configured to determine an amount of the supplemental braking torque to be applied based at least in part on the rate of change of the traction motor speed and the amount of pressure applied to the brake pedal.

Example 20 provides the braking assist system of any one of examples 17-19, in which the motor controller is further configured to: determine a grade of a surface being traversed by the vehicle; and refrain from the issuing the supplemental braking torque command while the grade is greater than a predetermined threshold grade.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C. The terms “substantially,” “close,” “approximately,” “near,” and “about,” generally refer to being within +/−5-20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A braking assist method for a vehicle, the method comprising:
receiving a brake switch signal indicative of a state of a mechanical brake actuation system;
receiving a motor speed signal indicative of a speed of a traction motor, the traction motor for applying rotational torque to a wheel of the vehicle;
determining from changes in a value of the received motor speed signal over time a rate of change of the traction motor speed; and
based on a determination that the mechanical brake actuation system is in an on state and that the rate of change of the traction motor speed is decreasing, commanding the traction motor to apply a supplemental braking torque to the wheel.

2. The braking assist method of claim 1, wherein the mechanical brake actuation system includes a brake pedal, the method further comprising determining from the brake switch signal whether the brake pedal has been pressed by an operator of the vehicle.

3. The braking assist method of claim 2, further comprising determining an amount of pressure applied to the brake pedal and preventing the commanding while the pressure is less than a predetermined threshold amount.

4. The braking assist method of claim 1, further comprising determining an amount of the supplemental braking torque to be applied based at least in part on the rate of change of the traction motor speed.

5. The braking assist method of claim 1, further comprising:
determining whether a current threshold of at least one of the traction motor or a battery of the vehicle has been exceeded; and
based on a determination that the current threshold has been exceeded, engaging a parking brake of the vehicle to provide an additional braking force.

6. The braking assist method of claim 1, further comprising:
determining a grade of a surface being traversed by the vehicle; and
preventing the commanding while the grade is greater than a predetermined threshold grade.

7. The braking assist method of claim 6, wherein the determining the grade of the surface is performed using signals received from an inertial measurement unit (IMU).

8. The braking assist method of claim 1, further comprising determining an amount of the supplemental braking torque to be applied, wherein the determined amount of supplemental braking torque, when applied, causes the vehicle to decelerate at a rate greater than a minimum threshold deceleration rate and less than a maximum deceleration rate.

9. An electric vehicle comprising a braking assist system, the electric vehicle comprising:
a mechanical brake actuation system for actuating a mechanical braking assembly in connection with a wheel of the vehicle;
a traction motor for applying rotational torque to the wheel; and
a motor controller for controlling the traction motor, the motor controller configured to receive a brake switch signal indicative of a state of the mechanical brake actuation system and a motor speed signal indicative of a speed of the traction motor;
wherein the motor controller is further configured to:
determine from changes in the received motor speed signal over time a rate of change of the traction motor speed; and
based on a determination that the mechanical brake actuation system is in an on state and that the rate of change of the traction motor speed is decreasing, command the traction motor to apply a supplemental braking torque to the wheel.

10. The vehicle of claim 9, wherein the mechanical brake actuation system includes a brake pedal, and wherein the motor controller is further configured to determine an amount of pressure applied to the brake pedal by an operator of the vehicle.

11. The vehicle of claim 10, wherein the motor controller is further configured to refrain from the commanding while the pressure is less than a predetermined threshold amount.

12. The vehicle of claim 9, wherein the motor controller is further configured to determine an amount of the supplemental braking torque to be applied based at least in part on the rate of change of the traction motor.

13. The vehicle of claim 9, wherein the motor controller is further configured to:
determine whether a current threshold of at least one of the traction motor or a battery of the vehicle has been exceeded; and
based on a determination that the current threshold has been exceeded, engage a parking brake of the vehicle to provide an additional braking force.

14. The vehicle of claim 9, wherein the motor controller is further configured to:
determine a grade of a surface being traversed by the vehicle; and
refrain from the commanding while the grade is greater than a predetermined threshold grade.

15. The vehicle of claim 14 further comprising an inertial measurement unit (IMU), wherein the grade of the surface being traversed is performed using signals received from the IMU.

16. The vehicle of claim 9, wherein the motor controller is further configured to determine an amount of the supplemental braking torque to be applied, wherein the determined amount of supplemental braking torque, when applied, causes the vehicle to decelerate at a rate greater than a minimum threshold deceleration rate and less than a maximum deceleration rate.

17. A braking assist system for an electric vehicle, the braking assist system comprising:
a motor controller configured to receive a brake switch signal indicative of a state of a mechanical brake actuation system of the vehicle and a motor speed signal indicative of a speed of a traction motor of the vehicle, wherein the motor controller is further configured to:
determine from changes in the received motor speed signal over time a rate of change of the traction motor speed; and
based on a determination that the mechanical brake actuation system is in an on state and that the rate of change of the traction motor speed is decreasing, command the traction motor to apply a supplemental braking torque to the wheel.

18. The braking assist system of claim 17 wherein the mechanical brake actuation system includes a brake pedal, and wherein the motor controller is further configured to determine from the brake switch signal whether pressure is applied to the brake pedal by an operator of the vehicle.

19. The braking assist system of claim 17, wherein the motor controller is further configured to determine an amount of the supplemental braking torque to be applied based at least in part on the rate of change of the traction motor speed.

20. The braking assist system of claim 17, wherein the motor controller is further configured to:
determine a grade of a surface being traversed by the vehicle; and
refrain from the issuing the supplemental braking torque command while the grade is greater than a predetermined threshold grade.
